(19) United States
(12) Patent Application Publication
(10) Pub. No.: US 2004/0039461 A1
(43) Pub. Date: Feb. 26, 2004

(54) Method of estimating pari-mutuel place and show odds/payoffs prior to a race or competition

(76) Inventor: Raymond Theodore Stefani, Lake Forest, CA (US)

Correspondence Address: Raymond T. Stefani, 25032 Via Del Rio, Lake Forest, CA, 92630, US

(21) Appl. No.: 10/224,558

(22) Filed: Aug. 21, 2002

(51) Int. Cl. A63F 13/00

(52) U.S. Cl. 700/91

(57) ABSTRACT

This patent relates to horse racing or any contest with a pari-mutuel payoff as practiced in the USA. To calculate the exact payoff for a place bet, it is necessary to know the entrants finishing first and second. To calculate the exact payoff for a show bet, it is necessary to know the entrants finishing first, second and third. For a given entrant, the procedure of this patent estimates the most likely amount of money bet on the other successful place entrant and on the other two successful show entrants, from which follows each estimated place and show payoff. Based on a study of 100 thoroughbred races at major racetracks, the average estimated place and show payoff (before the race) was within breakage (round off difference) of the actual payoff. Such estimates provide better information to each prospective bettor. Further, a greater amount may be bet to place and show.

### DESCRIPTION

1. Field of the Invention

This patent provides an improvement in the calculating and posting of certain potential pari-mutuel payoffs, prior to the completion of competition. This patent applies directly to place and show payoffs for horse racing. The invention covered herein may be applied to other contests/competitions upon which the pari-mutuel method is used for calculating the potential payoff and upon which this invention is applied to estimate any value similarly to the method disclosed.

2. Description of Prior Art

A patent search for the term pari-mutuel” or variation thereof, yields a significant number of patents, which convert fixed-odds games of chance into pari-mutuel games of chance. Such games become legal in those states that only allow pari-mutuel gambling. The current patent improves on any pari-mutuel gambling system, using place and show payoffs (either formerly pari-mutuel or newly-adjusted to become pari-mutuel).

Only two patents were found that deal directly with calculating place and/or show odds. U.S. Pat. No. 4,001,551, “Calculator”, from 1974, deals with a slide-rule device that can calculate a place or show payoffs where the user must select the given entrant and other successful entrants and then input the fraction of money bet on each such entrant. The result is subject to errors caused by misalignment and round off of a slide rule and subject to the ability of the user to guess at the actual successful place and show entrants. Since the granting of that patent, small calculators are readily available by which any user can easily carry out the same calculations with greater accuracy and speed. Many such computer programs/systems are easily found by browsing the Internet. The current patent improves on any such mode of calculation in that the current patent provides one estimated place and show payoff for each given entrant and the accuracy of each estimate is predicted also. There is no required guesswork for the user.

U.S. Pat. No. 5,564,977, “Integrated racetrack display system including display of periodic parimutuel data”, mentions the streaming and posting of place data. However, place data therein pertains to TAB (Totalisator Activity Board) horse races in Australia and New Zealand, where place betting deals with the first, second and third finishers (much like USA show betting); and, each pari-mutuel place payoff is calculated differently than in the USA. Under the rules in Australia and New Zealand, the place payoff on a given horse does not depend on the other successful place entrants; hence, such a display system would not be applicable to place payoffs as practiced in the USA and as covered in the current patent.

### DISCUSSION OF THE BACKGROUND OF THIS INVENTION

1. This patent provides an improvement in the calculating and posting of certain potential pari-mutuel payoffs, prior to the completion of competition. This patent applies directly to place and show payoffs for horse racing. The invention covered herein may be applied to other contests/competitions upon which the pari-mutuel method is used for calculating the potential payoff and upon which this invention is applied to estimate any value similarly to the method disclosed. The term “entrant” shall be used rather than “horse” since the invention is not restricted to horse racing.

a. Let there be N pari-mutuel entrants for a given type of bet. Let bₙ represent the amount of money bet on entrant n, for that type of bet. For convenience, the entrants are numbered herein by n=1 up to n=N in consecutive integers. An actual system may report available entrants to the bettors with any other designation and the actual accounting system used to calculate the potential payoffs may use another method to designate each of the N entrants. This patent covers any such variation. In horse racing, two or more horses may be combined to form an “entry”. The total bet on each horse of the entry is summed to provide one pari-mutuel entrant, as described herein. There may be a limit to the number of such entrants that may be handled by a pari-mutuel accounting system. In such cases, horses exceeding the limit may be combined to form the “field” and again all bets on the horses are summed to form one entrant, for purposes of pari-mutuel accounting. T represents the gross bet, which is the total of the N bets for the given type of bet. In mathematical terms

$$T = {\sum }_{n = 1}^{N} {b}_{n}$$

Some fraction of the gross bet, called the net bet, is returned to successful bettors. Let that fraction be denoted by m. In horse racing m is roughly between 0.80 and 0.85. Then the net bet is given by mT.

b. This patent refers to place and show betting. Win betting is now covered to contrast that situation with place and show betting. This patent does not otherwise apply to win betting. For win betting, to establish the total amount to be returned to each bettor that bet on the winning entrant, for every $2 bet, one first finds a potential payoffs pᵢ if entrant i wins.

pᵢ=2(mT/bᵢ)

Next, a form of rounding off is applied to pᵢ referred to as “breakage”. For breakage, the portion in the ( ), called “decimal odds” is reduced to the next lowest increment of 0.1, with a lower limit that is often 0.05. That is, in terms of a $2 bet, the next lowest increment of 0.2 is used with a minimum that is often 0.1. The potential payoff for each entrant may be calculated and displayed prior to a race, separately from every other entrant. When the race is over, pᵢ is exactly given by the last value reported when the betting was terminated. If $10000 is the total win bet on a race where 80% of the money is returned and $1500 is bet on the winning entrant, entrant 4, then p₄=2(0.8*10000/1500) or 10.67. With breakage the payoff per $2 bet becomes 10.60. Dollar signs are usually omitted.

c. In place betting, a bettor chooses a given entrant and that bettor receives a payoff if the given entrant finishes first or second. Let bᵢ represent the bet on a given entrant and bⱼ represent the bet on a second entrant. If the two entrants finish first and second in any order, the total payoff for the given entrant, for a $2 bet is

pᵢ=2(1+(mT−bᵢ−bⱼ)/2/bᵢ)

Breakage is applied in the same manner as for a win bet. Using current practice, for a given entrant numbered i, the potential payoff cannot be reported to bettors before a race since the identity of the other place entrant is not yet known. It is possible to report the largest possible payoff (using the smallest values for bᵢ and bⱼ) and the smallest possible payoff (using the largest values for bᵢ and bⱼ). Most bettors must guess at the value for a given entrant, based on displayed potential payoff to win. For a given entrant, this patent provides an estimate of bⱼ, the amount bet on the other successful entrant. After a race is over, if $10000 is the total place bet on a race where 80% of the money is returned, $2300 is bet on horse 4 to place, $1700 is bet on horse 6 to place, and horses 4 and 6 come in first and second, then p₄=2(1+(0.8* 10000-2300-1700)/2/2300) or 3.74. With breakage the payoff per $2 bet is $3.60.

d. In show betting, a bettor chooses a given entrant and that bettor receives a payoff if the given entrant finishes first, second or third. Let bᵢ represent the bet on a given entrant while bⱼ and bₖ represent the bets on two other entrants. If the three entrants finish first, second and third in any order, the total payoff for the given entrant, for a $2 bet is

pᵢ=2(1+(mT−bᵢ−bⱼ−bₖ)/3/bi)

Breakage is applied in the same manner as for a win bet. Using current practices, for a given entrant numbered i, the potential payoff cannot be reported to bettors before a race since the identity of the other two show entrants is not yet known. It is possible to report the largest possible payoff (using the smallest values for bᵢ, bⱼ and bₖ) and the smallest possible payoff (using the largest values for bᵢ, bⱼ and bₖ). As with place betting, most bettors must currently guess at the value for a given entrant, based on displayed potential payoff to win. For a given entrant, this patent provides estimates of bⱼ and bₖ, the amount bet on the other two successful entrants. After a race is over, if $10000 is the total show bet on a race where 80% of the money is returned, $2300 is bet on entrant 4 to show, $1700 is bet on entrant 6 to show, $1000 is bet on entrant 2 to show and entrants 2, 4 and 6 come in first, second and third, then p₄=2(1+(0.8*10000-2300-1700-1000)/3/2300) or 2.87. With breakage the payoff per $2 bet is 2.80.

### BRIEF SUMMARY OF THE INVENTION

2. For a given horse or competitor (henceforth referred to as “entrant”) in a pari-mutuel race under rules practiced in the USA, a procedure is invented for estimating the most likely amount of money bet on the other successful place entrant (the other entrant finishing first or second).

3. For a given entrant, a procedure is invented for estimating the most likely amount of money bet on the other two successful show entrants (the other entrants finishing first, second or third).

4. Using the estimated amount of money bet on the other successful place entrant using the invention, one can estimate the payoff for a successful place bet on each given entrant.

5. Using the estimated amount of money bet on the other successful show entrants using the invention, one can estimate the payoff for a successful show bet on each given entrant.

6. Any manner of rounding off the estimated payoffs and any manner of transmitting that information to prospective bettors in such forms as integer odds, decimal odds or any other manner or fashion is claimed by this patent and discussed below.

7. There may be an economic benefit of the invention due to potentially higher amounts bet.

### SUMMARY OF THE INVENTION

8. In what follows, an estimate is indicated by an underline. This patent provides a method of estimating, for a given place horse i, the amount bet on the other successful place horse, j; that is, an estimate bⱼ. The same method is used for estimating, for a given show horse i, the amount bet on the other two successful show horses, j and k, that is, estimates of bⱼ and bₖ. For show use, it is assumed that bⱼ and bₖ are equal so one simply doubles the estimate of the money bet on another horse that shares the payoff. Although the inventive equation is relatively simple, it does not follow at all that this invention is an obvious derivation; otherwise, such a derivation would have already occurred at some time in the last 100 years during which pari-mutuel betting has been in common use. Further, this invention is of economic benefit as will be demonstrated and it is worthy of patent protection.

a. For place (or show) betting, let betting data be collected as in 1.a. where T is the total bet and the N values of bₙ are the amounts bet on each entrant. For one form of this invention, let fₙ represent the fraction bet on horse n, given by bₙ/T. Next, for a given horse i, the invention estimates the most likely amount bet on another horse sharing the payoff, where that horse is designated j. That estimated amount bet is designated bⱼ and is found by taking the average weighted bet for the horses other than i, using the fraction bet on each horse as a weighting factor. This form of the invention is

$${\underline{b}}_{j} = \frac{{\sum }_{{n = 1}_{n \neq i}}^{N} {f}_{n} {b}_{n}}{{\sum }_{{n = 1}_{n \neq i}}^{N} {f}_{n}}$$

b. In order to estimate a value for each of the N entrants, the version of the invention in 8.a. requires finding N summations of each numerator and denominator. An equivalent equation requires only one summation. This patent protects any use of the disclosed procedure, which creates nearly the same value; that is, any modification or perturbation of 8.a. is covered which creates nearly the same value.

$${\underline{b}}_{j} = \frac{( {\sum }_{n = 1}^{N} {f}_{n} {b}_{n} ) - {f}_{i} {b}_{i}}{1 - {f}_{i}}$$

c. The following version of the invention results by multiplying the numerator and denominator of the equation in 8.b. by T.

$${\underline{b}}_{j} = \frac{( {\sum }_{n = 1}^{N} {b}_{n}^{2} ) - {b}_{i}^{2}}{T - {b}_{i}}$$

This version is particularly efficient for incorporation into an existing pari-mutuel calculating system, since any such system already has the total bet and the amount bet on each horse. It is only necessary to find the sum of the squares of the amounts bet and the squares of the amounts bet on each horse.

9. If any of 8.a., 8.b., 8.c. or equivalent are used to estimate of the amount bet on the other successful place entrant as regards entrant i, then 1.c. may be used to estimate the payoff for entrant i where bⱼ replaces bⱼ and the estimated payoff is designated pᵢ.

a. This patent protects the use of 1.c in conjunction with the estimate of 8.a or equivalent where

pᵢ=2(1+(kT−bᵢ−bⱼ)/2/bᵢ)

b. Table 1 illustrates the invention applied to actual place betting data.

TABLE 1
Place Betting Data, Race 2, Hollywood Park, June 30, 2001

| | Horse | | | Weighted | | Estimate | |
|---|---|---|---|---|---|---|---|
| Entrant i | Name | Bet b₁ | Fraction, f₁ | Bet f₁b₁ | Estimate bⱼ | p₁ | Actual p₁ |
| 1 | Bills' Paid | 10474 | 0.151 | 1582 | 16360 | 5.00 | 5.40 |
| 2 | Tortuguero | 9453 | 0.137 | 1295 | 16428 | 5.40 | |
| 3 | Pie N | 22778 | 0.329 | 7494 | 11890 | 3.00 | |
| | Burger | | | | | | |
| 4 | Rocky Bar | 12223 | 0.177 | 2163 | 16171 | 4.40 | 4.80 |
| 5 | Coil N | 14260 | 0.206 | 2938 | 15786 | 3.80 | |
| | Strike | | | | | | |
| Total | | 69188 | 1.000 | 15472 | | | |

Column three shows the amount bet on each horse to place and the total bet of $69188. Column four shows the fraction bet on each horse. For horse 1, fᵢ is 10474/69188 or 0.151. Column five is the product of columns three and four. For horse 1, 1582 is 10474*0.151. Next, the form of the invention for 8.b. is used to estimate the amount bet on the other place horse if horse 1 places. Using 8.b. for horse 1, bⱼ is given by (15472-1582)/(1-0.151) or $16360. Each estimate payoff, pᵢ, is shown after breakage rules have been applied. For horse 1, the use of 9.a. results in 2(1+(0.8457*69188-10474-16360)/2/10474) or $5.02. The breakage rule is then applied, rounding the result to $5.00. Actually, horse 1 did place along with horse 4. The estimated payoffs are within $0.40 of the actual payoffs.

c. A more comprehensive validation was performed of 100 horse races, including the one above. These 100 races provide 200 place estimates. The races are listed in Table 2 below.

TABLE 2
100 Races Used in Validation Study Including Values of m

| Track | Date | Number of Races | Race Numbers |
|---|---|---|---|
| Calder (m = 0.82) | June 9, 2001 | 10 | 1-10 |
| Churchill Downs | June 9, 2001 | 10 | 1-10 |
| (m = 0.84) | | | |
| Hollywood Park | June 9, 2001 | 8 | 1-5, 7-9 |
| (m = 0.8457) | | | |
| Hollywood Park | June 30, 2001 | 9 | 1-9 |
| (m = 0.8457) | | | |
| Calder (m = 0.82) | June 30, 2001 | 9 | 1-3, 5, 7-10, 12 |
| Churchill Downs | June 30, 2001 | 9 | 1-4, 6-10 |
| (m = 0.84) | | | |
| Hollywood Park | July 1, 2001 | 9 | 1-4, 6-10 |
| (m = 0.8457) | | | |
| Arlington (m = 0.83) | July 1, 2001 | 10 | 1-10 |
| Calder (m = 0.82) | July 1, 2001 | 8 | 1-7, 9 |
| Churchill Downs | July 1, 2001 | 10 | 1-10 |
| (m = 0.84) | | | |
| Arlington (m = 0.83) | July 20, 2001 | 8 | 1-2, 4-9 |

Table 3 summarizes the results.

TABLE 3
Result of 200 Place Estimates (Error is predicted - actual, payoff
is per $2 bet)

| | |
|---|---|
| Average error | −0.08 |
| Standard deviation of the error | 1.69 |
| Average predicted place payoff | 6.54 |
| Average actual place payoff | 6.62 |
| Errors ±0.00 to ±0.19 | 28 |
| Errors ±0.20 to ±0.39 | 53 |
| Errors ±0.40 to ±0.59 | 38 |
| Errors ±0.60 to ±0.79 | 21 |
| Errors ±0.80 to ±0.99 | 15 |
| Errors ±1.00 to ±1.49 | 18 |
| Errors ±1.50 to ±1.99 | 5 |
| Errors ±2.00 to ±2.49 | 4 |
| Errors ±2.50 to ±2.99 | 2 |
| Errors ±3.00 or more | 16 |

Here, error is defined as the predicted payoff per $2 bet minus the actual payoff. The average error, equal to −0.08, is less than half of breakage or round off error. Note that 119/200 estimates, nearly 60%, are within $0.60 (three times round off error). The invention is capable of accurately estimating eventual place payoff prior to a race, without knowing the other place horse.

10. If any of 8.a., 8.b., 8.c. or equivalent are used to estimate of the amount bet on the other successful show entrants as regards entrant i, then 1.d. may be used to estimate the payoff for entrant i where bⱼ replaces both bⱼ and bₖ and the estimated payoff is designated pᵢ.

a. This patent protects the use of 1.d in conjunction with the estimate of 8.a or equivalent where

pᵢ=2(1+(kT−bᵢ−2bⱼ)/3/bᵢ)

b. Table 1 illustrates the invention applied to actual place betting data.

TABLE 4
Show Betting Data, Race 2, Hollywood Park, June 30, 2001

| | Horse | | | Weighted | | Estimate | |
|---|---|---|---|---|---|---|---|
| Entrant i | Name | Bet b₁ | Fraction, f₁ | Bet f₁b₁ | Estimate bⱼ | p₁ | Actual p₁ |
| 1 | Bills' Paid | 2855 | 0.154 | 440 | 4437 | 2.80 | 3.20 |
| 2 | Tortuguero | 2591 | 0.140 | 363 | 4455 | 3.00 | |
| 3 | Pie N | 6222 | 0.336 | 2091 | 3167 | 2.20 | |
| | Burger | | | | | | |
| 4 | Rocky Bar | 2864 | 0.155 | 444 | 4438 | 2.80 | 3.20 |
| 5 | Coil N | 3981 | 0.215 | 856 | 4252 | 2.40 | 2.80 |
| | Strike | | | | | | |
| Total | | 18513 | 1.000 | 4194 | | | |

Column three shows the amount bet on each horse to place and the total bet of $18513. Column four shows the fraction bet on each horse. For horse 1, fᵢ is 2855/18513 or 0.154. Column five is the product of columns three and four. For horse 1, 440 is 2855*0.154. Next, the form of the invention from 8.b is used to estimate the amount bet on the other show horses if horse 1 places. Using 8.b for horse 1, bⱼ is given by (4194-440)/(1-0.154) or $4437. Each estimate payoff, pᵢ, is shown after breakage rules have been applied. For horse 1, the use of 10.a results in 2(1+(0.8457*18513-2855-2*4437)/3/2855) or $2.92. The breakage rule is then applied, rounding the result to $2.80. Actually, horse 1 did show along with horses 4 and 5. The estimated payoffs are within $0.40 of the actual payoffs.

c. A more comprehensive validation was performed of 100 horse races, including the one above, as listed in Table 2. These 100 races provide 300 show estimates summarized in Table 5.

TABLE 5
Result of 300 Place Estimates (Error is predicted - actual, payoff
is per $2 bet)

| | |
|---|---|
| Average error | −0.18 |
| Standard deviation of the error | 0.96 |
| Average predicted place payoff | 3.92 |
| Average actual place payoff | 4.10 |
| Errors ±0.00 to ±0.19 | 79 |
| Errors ±0.20 to ±0.39 | 75 |
| Errors ±0.40 to ±0.59 | 45 |
| Errors ±0.60 to ±0.79 | 36 |
| Errors ±0.80 to ±0.99 | 20 |
| Errors ±1.00 to ±1.49 | 28 |
| Errors ±1.50 to ±1.99 | 4 |
| Errors ±2.00 to ±2.49 | 2 |
| Errors ±2.50 to ±2.99 | 4 |
| Errors ±3.00 or more | 7 |

Again, error is defined as the predicted payoff per $2 bet minus the actual payoff. The average error, equal to −0.18, is less than the breakage or round off error. Note that 199/300 estimates, 66%, are within $0.60 (three times round off error). The invention is capable of accurately estimating eventual show payoff prior to a race, without knowing the other two show horses.

11. Each estimated payoff can be rendered into a number of different forms and then presented to a bettor. There are at least four common forms. First, as above, the total payoff, including profit, can be shown per $2 bet. For example, without the dollar sign, a potential payoff could be shown as 5.60, after breakage rules have been applied, consisting of the bettor's original $2 and a profit of $3.60. Second, the total payoff per $1 bet can be shown including profit, often called “decimal odds”. Here that would be shown as pᵢ/2 or 2.80, consisting of a $1 bet and $1.80 of profit. Thirdly, the “decimal odds” can be shown as just the profit for a $1 bet, here equal to 1.80 or (pᵢ/2−1). Fourth, the payoff can be rendered into “integer odds”, shown in the form profit:bet, which here is (pᵢ/2−1):1 or 1.8:1; which becomes 9:5 after multiplying both sides of the ratio by 5. This patent covers any of the common forms of displaying odds or any other form based on the procedure. Any application to any other pari-mutuel system than horse racing of any kind or sort is also covered. Any addition of small perturbations leaving the basic result nearly unchanged and any mode or device used to carry out the calculations of any kind or sort are covered by this patent.

12. The odds/payoffs presented to each bettor, provide better information than having to guess at place and show odds/payoffs from the posted win odds/payoff. Further, that increased information may induce the average bettor to bet more money. For the 100 races of Table 2, the total place bet was 34.5% of the win bet while the total show bet was 16.8% of the win bet. These figures can be contrasted with data from Australia where betting is legal nationwide. The Totalisator Agency Board or TAB oversees all Australian betting nationwide, including horse racing on-track and off-track betting. Among the legal bets, are bets to win and their version of a place bet, which, like the USA show bet, provides a return for selecting the horse finishing first, second or third. The Australian pari-mutuel payoff is calculated in such a way that the odds/payoffs can be posted prior to the race. With that information, the TAB for nationwide Australian betting in 1999/2000, indicates that total place bets (like USA show bets) equaled 40.3% of the win bet, 16.8% more than for the place betting in the 100 USA races covered in Table 2 and 139.9% more than the show betting in those same 100 races. This patent claims only to provide better information to each prospective bettor, but it is possible that significantly higher betting turn over could result with significantly higher profit to a betting agency, given that additional direct costs of talking additional place and show bets would be minimal.

Table 6 summarizes predicted and actual payoffs (per $2 bet) for the two place horses and three show horses, for each of 100 races numbered consecutively below. For each race, the track, race number for that date and the date in the year 2001 are shown followed by predicted and actual payoffs for each successful place and show horse.

TABLE 6
100 Races.

| | Place | | Place | | Show | | Show | | Show | |
|---|---|---|---|---|---|---|---|---|---|---|
| ## Trck/##/Date | Pred. | Act. | Pred. | Act. | Pred. | Act. | Pred. | Act. | Pred. | Act. |
| 1 Calder 1 6-9 | 2.20 | 2.40 | 8.20 | 6.00 | 2.10 | 2.10 | 2.10 | 2.60 | 2.10 | 3.00 |
| 2 Calder 2 6-9 | 3.40 | 3.80 | 13.60 | 12.20 | 2.60 | 2.60 | 2.40 | 2.60 | 7.60 | 5.60 |
| 3 Calder 3 6-9 | 2.40 | 2.20 | 3.00 | 2.40 | 2.10 | 2.10 | 2.10 | 2.10 | 2.10 | 2.10 |
| 4 Calder 4 6-9 | 3.20 | 3.60 | 5.80 | 5.60 | 2.60 | 3.20 | 3.60 | 4.40 | 3.20 | 3.80 |
| 5 Calder 5 6-9 | 2.60 | 2.80 | 11.80 | 8.80 | 2.20 | 2.40 | 5.80 | 5.80 | 5.00 | 5.20 |
| 6 Calder 6 6-9 | 9.20 | 10.20 | 6.40 | 7.20 | 4.40 | 3.80 | 2.40 | 2.40 | 3.20 | 3.20 |
| 7 Calder 7 6-9 | 6.40 | 5.80 | 3.40 | 3.40 | 3.40 | 3.40 | 4.80 | 4.40 | 2.60 | 2.80 |
| 8 Calder 8 6-9 | 13.20 | 12.40 | 4.40 | 4.80 | 6.80 | 5.80 | 3.40 | 3.40 | 3.00 | 3.00 |
| 9 Calder 9 6-9 | 3.60 | 3.00 | 3.00 | 2.80 | 2.60 | 2.40 | 3.80 | 3.00 | 2.40 | 2.20 |
| 10 Calder 10 6-9 | 3.60 | 3.20 | 3.40 | 3.00 | 4.00 | 3.40 | 2.80 | 2.60 | 2.80 | 2.80 |
| 11 CDowns 1 6-9 | 3.40 | 3.40 | 5.60 | 5.00 | 4.20 | 4.00 | 2.60 | 2.80 | 3.40 | 3.60 |
| 12 CDowns 2 6-9 | 11.40 | 7.40 | 2.40 | 2.40 | 4.80 | 6.00 | 3.00 | 4.00 | 2.10 | 2.20 |
| 13 CDowns 3 6-9 | 4.80 | 5.00 | 5.60 | 5.60 | 3.00 | 3.40 | 3.60 | 4.00 | 4.00 | 4.40 |
| 14 CDowns 4 6-9 | 6.40 | 6.60 | 4.80 | 5.40 | 2.80 | 2.80 | 4.20 | 3.80 | 3.20 | 3.20 |
| 15 CDowns 5 6-9 | 4.20 | 3.80 | 3.20 | 3.20 | 2.80 | 2.40 | 2.60 | 2.40 | 2.60 | 2.20 |
| 16 CDowns 6 6-9 | 4.00 | 3.80 | 4.40 | 4.00 | 4.20 | 3.60 | 3.00 | 2.80 | 3.20 | 3.20 |
| 17 CDowns 7 6-9 | 3.00 | 3.00 | 8.20 | 6.60 | 3.00 | 2.80 | 2.40 | 2.40 | 4.40 | 3.80 |
| 18 CDowns 8 6-9 | 5.20 | 5.60 | 4.60 | 5.00 | 2.80 | 3.80 | 2.80 | 3.60 | 3.80 | 4.80 |
| 19 CDowns 9 6-9 | 6.80 | 6.40 | 3.60 | 3.80 | 4.60 | 5.60 | 12.60 | 14.20 | 2.40 | 3.00 |
| 20 CDowns 10 6-9 | 8.60 | 9.40 | 8.00 | 8.80 | 6.00 | 7.40 | 10.20 | 12.40 | 4.40 | 5.80 |
| 21 HPark 1 6-9 | 3.80 | 3.60 | 5.20 | 4.60 | 2.80 | 3.00 | 5.80 | 5.20 | 3.80 | 3.60 |
| 22 HPark 2 6-9 | 14.40 | 9.80 | 2.20 | 2.40 | 2.10 | 2.10 | 2.10 | 2.10 | 2.10 | 2.10 |
| 23 HPark 3 6-9 | 9.20 | 14.00 | 17.40 | 25.80 | 3.40 | 8.40 | 4.40 | 11.00 | 2.20 | 5.00 |
| 24 HPark 4 6-9 | 4.40 | 3.80 | 3.60 | 3.40 | 3.60 | 3.00 | 3.00 | 2.60 | 3.20 | 2.80 |
| 25 HPark 5 6-9 | 7.00 | 6.20 | 3.80 | 3.80 | 4.40 | 4.40 | 5.60 | 5.40 | 3.00 | 3.00 |
| 26 HPark 7 6-9 | 3.00 | 3.00 | 6.80 | 5.40 | 3.00 | 3.00 | 8.20 | 7.40 | 4.80 | 4.60 |
| 27 HPark 8 6-9 | 7.20 | 5.80 | 2.80 | 2.80 | 3.80 | 3.60 | 2.40 | 2.60 | 4.00 | 3.80 |
| 28 HPark 9 6-9 | 8.60 | 8.80 | 6.20 | 6.60 | 6.00 | 6.80 | 7.00 | 7.80 | 4.00 | 4.80 |
| 29 HPark 1 6-30 | 4.20 | 4.60 | 5.60 | 5.80 | 2.80 | 3.40 | 4.20 | 5.00 | 3.60 | 4.40 |
| 30 HPark 2 6-30 | 5.00 | 5.40 | 4.40 | 4.80 | 2.80 | 3.20 | 2.80 | 3.20 | 2.40 | 2.80 |
| 31 HPark 3 6-30 | 16.00 | 21.40 | 11.60 | 16.00 | 5.80 | 6.00 | 2.20 | 2.20 | 3.80 | 4.20 |
| 32 HPark 4 6-30 | 5.20 | 5.60 | 4.40 | 5.00 | 3.40 | 4.20 | 4.40 | 5.60 | 2.80 | 3.60 |
| 33 HPark 5 6-30 | 21.80 | 19.60 | 3.80 | 4.20 | 4.80 | 5.20 | 10.20 | 10.00 | 2.80 | 3.20 |
| 34 HPark 6 6-30 | 7.20 | 7.60 | 4.00 | 4.60 | 2.80 | 3.20 | 4.60 | 4.80 | 2.60 | 3.00 |
| 35 HPark 7 6-30 | 3.60 | 3.80 | 14.80 | 12.80 | 2.80 | 2.80 | 3.40 | 3.20 | 6.60 | 5.60 |
| 36 HPark 8 6-30 | 4.00 | 3.00 | 2.40 | 2.40 | 2.10 | 2.10 | 2.10 | 2.10 | 2.10 | 2.10 |
| 37 HPark 9 6-30 | 8.20 | 7.40 | 4.00 | 4.00 | 5.40 | 4.40 | 3.00 | 2.80 | 3.00 | 2.80 |
| 38 Calder1 6-30 | 11.00 | 9.20 | 3.00 | 3.40 | 2.80 | 2.80 | 6.00 | 5.00 | 2.40 | 2.40 |
| 39 Calder2 6-30 | 4.80 | 5.20 | 9.20 | 9.00 | 2.80 | 3.20 | 5.60 | 6.00 | 4.80 | 5.40 |
| 40 Calder3 6-30 | 15.60 | 12.80 | 2.60 | 3.00 | 5.20 | 6.20 | 5.00 | 6.00 | 2.20 | 2.80 |
| 41 Calder5 6-30 | 7.00 | 7.20 | 5.40 | 5.80 | 4.40 | 4.00 | 2.60 | 2.60 | 4.40 | 4.00 |
| 42 Calder7 6-30 | 3.20 | 3.00 | 6.00 | 4.80 | 5.20 | 4.60 | 2.40 | 2.40 | 4.00 | 3.60 |
| 43 Calder8 6-30 | 3.40 | 3.60 | 5.00 | 4.80 | 5.40 | 5.40 | 2.40 | 2.60 | 3.40 | 3.80 |
| 44 Calder9 6-30 | 3.80 | 3.80 | 7.20 | 6.20 | 7.00 | 6.40 | 2.60 | 2.80 | 5.60 | 5.20 |
| 45 Calder10 6-30 | 2.40 | 2.40 | 10.60 | 7.00 | 2.20 | 2.40 | 4.40 | 5.00 | 8.60 | 8.60 |
| 46 Calder12 6-30 | 5.40 | 5.40 | 6.00 | 6.00 | 2.80 | 3.00 | 4.40 | 4.20 | 5.80 | 5.40 |
| 47 CDowns1 6-30 | 3.80 | 4.40 | 8.00 | 8.00 | 3.00 | 3.60 | 2.80 | 3.40 | 3.80 | 4.60 |
| 48 CDowns2 6-30 | 4.00 | 4.20 | 5.40 | 5.40 | 2.80 | 3.40 | 3.40 | 3.80 | 3.60 | 4.20 |
| 49 CDowns3 6-30 | 4.00 | 4.20 | 4.20 | 4.40 | 2.40 | 2.40 | 2.80 | 2.60 | 2.80 | 2.60 |
| 50 CDowns4 6-30 | 8.80 | 8.00 | 3.80 | 4.00 | 4.80 | 4.60 | 3.60 | 3.60 | 3.20 | 3.20 |
| 51 CDowns6 6-30 | 4.00 | 3.80 | 6.80 | 6.00 | 4.00 | 3.40 | 3.00 | 2.80 | 4.60 | 4.00 |
| 52 CDowns7 6-30 | 3.80 | 3.20 | 2.80 | 2.80 | 2.60 | 2.20 | 2.20 | 2.10 | 2.60 | 2.20 |
| 53 CDowns8 6-30 | 3.40 | 3.80 | 8.00 | 7.40 | 2.60 | 2.60 | 4.00 | 3.60 | 3.20 | 3.00 |
| 54 CDowns9 6-30 | 2.80 | 2.40 | 2.40 | 2.20 | 2.80 | 2.20 | 2.10 | 2.10 | 2.10 | 2.10 |
| 55 CDowns10 6-30 | 18.20 | 22.20 | 23.40 | 28.40 | 10.00 | 14.60 | 11.00 | 15.80 | 11.60 | 16.60 |
| 56 HPark1 7-1 | 7.40 | 6.40 | 3.40 | 3.40 | 3.00 | 2.80 | 5.00 | 4.00 | 2.60 | 2.40 |
| 57 HPark2 7-1 | 2.60 | 2.80 | 4.60 | 3.80 | 2.60 | 2.80 | 2.10 | 2.20 | 2.60 | 2.80 |
| 58 HPark3 7-1 | 9.20 | 10.20 | 14.00 | 15.00 | 6.80 | 8.20 | 8.80 | 10.40 | 4.80 | 5.80 |
| 59 HPark4 7-1 | 19.20 | 28.60 | 17.20 | 25.60 | 2.10 | 2.20 | 3.60 | 6.60 | 3.00 | 5.60 |
| 60 HPark6 7-1 | 15.80 | 13.40 | 3.60 | 3.80 | 8.60 | 6.80 | 2.80 | 2.80 | 3.20 | 3.20 |
| 61 HPark7 7-1 | 4.60 | 4.20 | 5.20 | 4.80 | 7.00 | 6.00 | 3.60 | 3.40 | 3.60 | 3.60 |
| 62 HPark8 7-1 | 6.60 | 6.40 | 5.40 | 5.60 | 4.60 | 5.40 | 3.20 | 3.80 | 13.80 | 14.40 |
| 63 HPark 9-1 | 6.80 | 6.40 | 4.40 | 4.60 | 2.80 | 2.80 | 4.00 | 3.40 | 3.20 | 3.00 |
| 64 HPark10 7-1 | 30.00 | 25.40 | 3.40 | 3.80 | 3.00 | 3.40 | 15.00 | 13.80 | 3.00 | 3.40 |
| 65 Arling1 7-1 | 19.60 | 21.20 | 7.40 | 8.60 | 4.80 | 5.60 | 7.40 | 8.20 | 4.00 | 4.80 |
| 66 Arling2 7-1 | 3.20 | 3.40 | 9.40 | 8.00 | 4.00 | 3.80 | 2.60 | 2.60 | 5.00 | 4.60 |
| 67 Arling3 7-1 | 4.20 | 3.80 | 3.60 | 3.40 | 6.60 | 5.60 | 3.20 | 3.20 | 3.00 | 3.00 |
| 68 Arling4 7-1 | 3.40 | 3.00 | 3.60 | 3.20 | 3.00 | 2.80 | 3.00 | 3.00 | 7.00 | 5.60 |
| 69 Arling5 7-1 | 3.00 | 3.20 | 6.60 | 5.40 | 4.80 | 4.40 | 2.60 | 2.80 | 3.80 | 3.60 |
| 70 Arling6 7-1 | 4.60 | 5.80 | 17.80 | 19.60 | 11.80 | 15.60 | 3.40 | 4.80 | 8.20 | 11.00 |
| 71 Arling7 7-1 | 7.00 | 6.80 | 4.40 | 4.60 | 5.20 | 4.40 | 3.20 | 3.00 | 3.00 | 2.80 |
| 72 Arling8 7-1 | 6.20 | 6.00 | 4.20 | 4.40 | 2.60 | 2.40 | 4.00 | 3.40 | 3.20 | 3.00 |
| 73 Arling9 7-1 | 5.00 | 4.20 | 3.20 | 3.20 | 3.20 | 2.80 | 3.60 | 3.00 | 2.60 | 2.40 |
| 74 Arling10 7-1 | 4.20 | 3.40 | 2.80 | 2.60 | 3.00 | 2.80 | 2.40 | 2.40 | 3.40 | 3.20 |
| 75 Calder1 7-1 | 5.20 | 5.80 | 3.80 | 4.40 | 3.20 | 4.80 | 2.20 | 3.20 | 2.40 | 3.60 |
| 76 Calder2 7-1 | 6.60 | 6.60 | 6.00 | 6.00 | 4.00 | 4.00 | 4.60 | 4.60 | 4.00 | 4.20 |
| 77 Calder4 7-1 | 5.80 | 5.80 | 4.20 | 4.60 | 4.80 | 6.20 | 3.20 | 4.20 | 2.60 | 3.60 |
| 78 Calder5 7-1 | 4.20 | 4.20 | 4.60 | 4.40 | 2.80 | 3.20 | 3.20 | 3.80 | 2.80 | 3.40 |
| 79 Calder6 7-1 | 3.40 | 4.00 | 4.20 | 4.60 | 2.10 | 2.20 | 2.10 | 2.10 | 2.10 | 2.20 |
| 80 Calder7 7-1 | 7.20 | 7.20 | 3.20 | 3.80 | 2.80 | 3.00 | 3.80 | 3.80 | 2.20 | 2.20 |
| 81 Calder9 7-1 | 3.00 | 2.60 | 3.00 | 2.60 | 2.20 | 2.10 | 2.40 | 2.20 | 2.40 | 2.20 |
| 82 Calder10 7-1 | 4.80 | 4.60 | 3.80 | 4.00 | 2.60 | 2.40 | 3.00 | 2.60 | 2.60 | 2.40 |
| 83 CDowns1 7-1 | 5.40 | 6.80 | 4.40 | 5.80 | 2.80 | 2.60 | 2.20 | 2.40 | 2.20 | 2.10 |
| 84 CDowns2 7-1 | 13.60 | 12.00 | 3.60 | 3.80 | 2.60 | 2.60 | 8.20 | 5.60 | 2.40 | 2.40 |
| 85 CDowns3 7-1 | 4.20 | 4.00 | 4.00 | 3.80 | 2.80 | 2.60 | 2.60 | 2.40 | 2.20 | 2.20 |
| 86 CDowns4 7-1 | 17.40 | 18.00 | 7.00 | 7.80 | 3.00 | 3.40 | 8.20 | 8.00 | 5.20 | 5.40 |
| 87 CDowns5 7-1 | 4.00 | 4.00 | 8.80 | 7.60 | 2.80 | 2.80 | 5.00 | 4.40 | 4.40 | 4.00 |
| 88 CDowns6 7-1 | 8.60 | 6.00 | 2.60 | 2.60 | 2.10 | 2.40 | 2.10 | 2.80 | 2.10 | 2.10 |
| 89 CDowns7 7-1 | 4.80 | 4.40 | 4.00 | 3.80 | 3.40 | 2.80 | 3.00 | 2.60 | 2.80 | 2.40 |
| 90 CDowns8 7-1 | 2.80 | 2.60 | 3.40 | 2.80 | 2.20 | 2.10 | 2.20 | 2.10 | 2.60 | 2.20 |
| 91 CDowns9 7-1 | 4.00 | 4.40 | 6.20 | 6.00 | 3.40 | 3.40 | 3.00 | 3.20 | 4.00 | 3.80 |
| 92 CDowns10 7-1 | 8.60 | 7.20 | 3.20 | 3.40 | 4.00 | 3.80 | 4.20 | 3.80 | 2.60 | 2.60 |
| 93 Arling1 7-20 | 5.40 | 5.80 | 5.80 | 6.20 | 3.40 | 3.20 | 3.60 | 3.40 | 2.40 | 2.60 |
| 94 Arling2 7-20 | 7.20 | 8.00 | 5.40 | 6.00 | 3.80 | 4.40 | 3.80 | 4.40 | 7.40 | 8.00 |
| 95 Arling4 7-20 | 6.40 | 7.20 | 15.40 | 15.60 | 5.00 | 5.00 | 3.00 | 3.20 | 8.40 | 7.60 |
| 96 Arling5 7-20 | 4.00 | 4.60 | 9.00 | 9.20 | 2.60 | 2.60 | 3.00 | 3.00 | 4.00 | 3.60 |
| 97 Arling6 7-20 | 4.80 | 4.20 | 3.80 | 3.60 | 3.80 | 3.60 | 5.40 | 4.80 | 3.00 | 3.00 |
| 98 Arling7 7-20 | 7.20 | 6.40 | 4.20 | 4.20 | 6.40 | 5.60 | 4.80 | 4.60 | 3.40 | 3.40 |
| 99 Arling8 7-20 | 21.80 | 18.00 | 3.20 | 3.40 | 7.80 | 6.40 | 2.60 | 2.60 | 3.40 | 3.40 |
| 100 Arling9 7-20 | 20.80 | 25.20 | 18.00 | 22.00 | 3.00 | 3.40 | 10.00 | 10.00 | 11.60 | 11.60 |

I hereby claim:

1. For a given horse or competitor (henceforth referred to as “entrant”) in a pari-mutuel race under rules practiced in the USA, a procedure for estimating the most likely amount of money bet on the other successful place entrant (the other entrant finishing first or second).

2. For a given entrant, a procedure for estimating the most likely amount of money bet on the other two successful show entrants (the other entrants finishing first, second or third).

3. Using the estimated amount of money bet on the other successful place entrant from claim 1, a procedure to estimate the payoff for a successful place bet on each given entrant.

4. Using the estimated amount of money bet on the other successful show entrants from claim 2, a procedure to estimate the payoff for a successful show bet on each given entrant.

5. Any manner of rounding off the estimated payoffs from claims 3 and 4 and any manner of transmitting that information to prospective bettors in such forms as integer odds, decimal odds or any other manner or fashion.
